(19) United States
(12) Patent Application Publication
(10) Pub. No.: US 2025/0059963 A1
(43) Pub. Date: Feb. 20, 2025

(54) Swivel Angle Measuring Device on a Hydrostatic Axial Piston Machine with Variable Stroke Volume

(71) Applicant: Robert Bosch GmbH, Stuttgart (DE)

(72) Inventors: Bernd Huehn, Elchingen (DE); Werner Tschaffon, Weissenhorn (DE)

(21) Appl. No.: 18/804,498

(22) Filed: Aug. 14, 2024

(30) Foreign Application Priority Data
Aug. 16, 2023 (DE) 10 2023 207 872.4
Sep. 29, 2023 (DE) 10 2023 209 572.6

(51) Int. Cl. F04B 1/324; F04B 1/122; G01B 7/30

(52) U.S. Cl. CPC F04B 1/324; F04B 1/122; G01B 7/30

(57) ABSTRACT

A swivel angle measuring device and a hydrostatic axial piston machine are disclosed having a swashplate, the swivel angle of which can be adjusted by way of an adjustment piston guided in an adjustment cylinder, and having a swivel angle measuring device, by way of which the swivel angle of the swashplate can be detected. The swivel angle measuring device includes a movable encoder formed by a permanent magnet and a transducer fixed to the housing. The swivel angle measuring device is translational, wherein the permanent magnet can be moved linearly and translationally by the adjustment piston along its direction of movement by way of a magnet coupling device.

This application claims priority under 35 U.S.C. § 119 to (i) patent application no. DE 10 2023 207 872.4, filed on Aug. 16, 2023 in Germany, and (ii) patent application no. DE 10 2023 209 572,6, filed on Sep. 29, 2023 in Germany, the disclosures of which are incorporated herein by reference in their entirety.

### BACKGROUND

The present disclosure relates to the detection of the swivel angle of a hydrostatic piston machine with adjustable stroke volume in a swashplate design.

From the prior art, hydrostatic axial piston machines with adjustable stroke volume in a swashplate design are known, the working pistons of which are coupled to a swashplate that is formed on a swivel cradle. In order to be able to adjust the stroke volume of the axial piston machine, the swivel cradle is pivotally mounted in the housing of the axial piston machine.

DE 10 2017 213 457 A1 shows such an axial piston machine, the swivel cradle of which is coupled to an adjustment piston of a hydrostatic adjustment device via a pivot formed with the swivel cradle in one piece and via a sliding block rotatably mounted thereon. The adjustment device has an adjustment cylinder configured as a screw-in installation sleeve in which the adjustment piston is accommodated in sections. The adjustment piston is double acting. The adjustment pressure mechanism is provided by an external adjustment pressure mechanism source.

In such axial piston machines, it is important to detect the swivel angle of the swivel cradle for the control and regulation tasks. Rotary swivel angle measuring devices are known from the prior art.

DE10 2014 200 566 A1 discloses a rotary swivel angle measuring device positioned on the (non-physical) swivel axis of the swivel cradle. Thus, the swivel angle is detected directly and without change (without transmission or reduction). The swivel angle measuring device has a shaft coupled to the swivel cradle via a rotary coupling device and a swivel cradle pin. The coupling device is a leaf spring made of spring steel. The disadvantage of such swivel angle measuring devices is the design space requirement.

DE 10 2010 045 540 A1 discloses an axial piston machine, the adjustment device of which comprises an adjustment piston to which a rotary swivel angle measuring device is coupled. This has a permanent magnet which is moved along a circular path past a swing angle transducer having a Hall sensor using a return lever. The return lever engages with its (free) end section in a receptacle of the adjustment piston.

Furthermore, it is known from in-house prior art to have the (free) end section of the return lever engage with the circumferential groove of the adjustment piston in the aforementioned axial piston machines with an adjustment piston and with a rotary swivel angle measuring device, in which the lever of the swivel cradle also engages. The swivel angle measuring device is inserted into a through-recess of the housing and thus seals the internal space of the axial piston machine in which tank pressure prevails.

The disadvantage of the latter two rotary swivel angle measuring devices and their transmission of a linear/translational adjustment piston movement into a rotary encoder movement is that the (free) end section of the return lever must always be moved in and out radially to the recess of the adjustment piston. In addition, the transmission of a comparatively wide movement of the adjustment piston (with increasing tendency) can only be converted into small rotational movements of the encoder at the end areas of the adjustment piston travel, whereby there is an increased risk of jamming. Furthermore, it is disadvantageous that the bearing of the return lever and the holder of the encoder magnet require increased design space in the axial direction of the bearing.

### SUMMARY

The object of the present disclosure is to avoid these disadvantages. The object is solved by a swivel angle measuring device having the features set forth below and by an axial piston machine having the features also set forth below.

The hydrostatic axial piston machine described herein has a swashplate formed on a swivel cradle, the swivel angle of which can be adjusted by way of an adjustment piston guided in an adjustment cylinder. To this end, the adjustment piston is mechanically coupled to the swashplate. A swivel angle measuring device also described herein is provided, via which the swivel angle of the swashplate can be detected, and which can also be referred to as swivel angle sensor arrangement or swivel angle sensor system. The swivel angle measuring device comprises a movable encoder formed by a permanent magnet and a transducer (preferably a Hall sensor) fixed to the housing. According to the disclosure, the swivel angle measuring device is translational, i.e., the permanent magnet is guided past the transducer in a translational relative movement. For this purpose, the permanent magnet can be moved linearly and translationally by the adjustment piston along its direction of movement by way of a magnet coupling device.

This avoids the radial movement of the (free) end section of the return lever into and out of the recess/groove of the adjustment piston, which is necessary with the rotary swivel angle measuring device of the prior art. In particular, the transmission of a comparatively wide movement of the adjustment piston can be converted into an undiminished wide translational or linear movement of the encoder at the end areas of the adjustment piston travel, whereby the risk of jamming remains low.

An adjustment piston housing may be penetrated by an elongated breakthrough in the direction of movement of the adjustment piston, along or in which the permanent magnet is guided for linear movement.

The breakthrough is preferably covered by a cover over its entire length, wherein a seal between the cover and the adjustment piston housing endlessly surrounds the breakthrough.

The transducer (e.g., Hall sensor) is accommodated in a (circular cylindrical) breakthrough of the cover in a sealing manner.

The adjustment piston can have a circumferential groove via which it is coupled (e.g., by way of a sliding block) to the swivel cradle. It is then simple and space-saving in terms of the device if the magnet coupling device is also immersed in this groove, at least in sections. The adjustment piston can be rotated about its axis. The magnet coupling device can therefore be moved in the groove in the circumferential direction of the adjustment piston.

In particularly preferred embodiments, the magnet coupling device has a spring element by way of which the permanent magnet is elastically braced with opposing side walls of the groove.

In particularly preferred embodiments, the magnet coupling device has a spring element that has two legs that are elastically movable relative to one another and that abut against opposing side walls of the groove under preload.

The spring element is preferably formed in one piece from spring steel (in particular in the stamping and bending procedure) or from a coil spring.

The magnet coupling device preferably has a magnet housing that preferably encompasses the permanent magnet on all sides. The magnet housing is preferably a one-piece or two-piece plastic injection molded part. It is important that this magnet housing is slide-optimized so that it can slide without jamming and with low resistance along the breakthrough of the cover, e.g., in a linear guide.

In a first embodiment of the magnet coupling device, the spring element has a flat main section that is attached to the side of the magnet housing facing the groove. The two legs extend from the main section.

The main section can have four webs or tabs, at each end of which a through-recess is formed, through each of which a plastically deformed lug of the magnet housing extends.

In a second embodiment of the magnet coupling device, it has the magnet housing mentioned above. The spring element has an angled (e.g., band-like or strip-like) main section that encompasses the magnet housing on a plurality of sides, e.g., on three sides that do not face the groove. A leg is formed at each of the two (free) end sections of the main section, which extends away from the magnet housing.

In a third embodiment of the magnet coupling device, it has the magnet housing mentioned above. Two webs or tabs are formed in one piece on the side of the magnet housing facing the groove (preferably molded using plastic injection molding), which extend into the groove and abut the side walls of the groove. The spring element is clamped between these two webs or tabs. Thus, the spring element has no direct contact to the side walls of the groove. It is particularly preferred if one of the webs or tabs has increased flexibility compared to the other web or other tab.

In a first further development of the third embodiment, the spring element has a main section attached to the magnet housing and two legs extending away from the main section. A through-recess may be formed on the main section of the spring element, through which a plastically deformed lug of the magnet housing extends.

In a second further development of the third embodiment, the spring element is a coil spring. This is preferably held at each end section on a round protrusion of the two webs or tabs.

A central main section of the spring element may be further formed into a channel-like or tub-like or trough-like receptacle for the permanent magnet. The magnet housing then encompasses the permanent magnet together with the receptacle.

In a fourth embodiment of the magnet coupling device, the channel-like receptacle is provided and the two legs extend through the side of the magnet housing facing the groove.

In a seventh embodiment of the magnet coupling device, the channel-like or tub-like or trough-like receptacle is provided and the magnet housing is formed from a profile that (apart from an optional clamping section on the side facing away from the groove) has a substantially constant cross-section over its length. The profile can be pushed or slid over the permanent magnet and the receptacle in the direction of movement of the adjustment piston. The seventh embodiment is provided as a stamping and bending part made of metal.

In a fifth embodiment of the magnet coupling device, it has two magnet housing halves, wherein the spring element has a main section from which the two legs and four retaining legs extend. The two magnet housing halves are clamped between the four retaining legs, wherein two retaining legs abut each magnet housing half. A through-recess can be formed on each retaining leg, and two clamping lugs can be formed on each magnet housing half, each of which extends into a through-recess. To compensate for the tolerance of the magnet housing halves, and when expanding during assembly via the clamping lugs, the retaining legs can be suitably designed in a Z-shape or S-shape to allow a larger deformation path.

In a sixth embodiment, a web or a tab is formed in one piece on the magnet housing, which abuts one of the side walls of the groove. A further web or tab is preferably slidably mounted on the magnet housing along the direction of movement of the adjustment piston. The two webs or tabs extend into the groove. The spring element is clamped between the two webs or tabs and presses them against the side walls of the groove. Thus, the spring element has no direct contact with the side walls of the groove.

In the sixth embodiment, the spring element is preferably a coil spring.

In order to prevent overloads on the spring element as a result of large amplitudes of the magnet coupling device, stops can be attached to the magnet housing. The spring element is thus only stressed up to a predefined stroke.

To this end, the two stops can be formed in one piece on the side of the magnet housing facing the groove in the form of domes that extend into the groove and that can be brought into contact with the side flanks of the groove.

The spring element can have a main section from which the two legs extend. In a space-saving further development, the two legs have respective through-recesses through which the domes can extend when the legs spring in.

An exemplary embodiment of the present disclosure will be described below with various exemplary embodiments of magnet coupling devices based on the accompanying figures.

### BRIEF DESCRIPTION OF THE DRAWINGS

FIG. 1 shows the exemplary embodiment of the swivel angle measuring device or the axial piston machine according to the disclosure;

FIG. 2 shows an adjustment device of the axial piston machine of FIG. 1 with a translational swivel angle measuring device;

FIG. 3 shows a permanent magnet with a first embodiment of the magnet coupling device for use in the swivel angle measuring device of FIG. 2;

FIG. 4 shows a second embodiment of the magnet coupling device for use in the swivel angle measuring device of FIG. 2;

FIGS. 5 and 6 show a permanent magnet with a third embodiment of the magnet coupling device for use in the swivel angle measuring device of FIG. 2;

FIG. 7 shows a fourth embodiment of the magnet coupling device for use in the swivel angle measuring device of FIG. 2;

FIG. 8 shows a spring element of the fourth embodiment of the magnet coupling device of FIG. 7;

FIG. 9 shows a fifth embodiment of the magnet coupling device for use in the swivel angle measuring device of FIG. 2;

FIG. 10 shows a magnet housing half of the magnet coupling device of FIG. 9;

FIG. 11 shows a sixth embodiment of the magnet coupling device for use in the swivel angle measuring device of FIG. 2;

FIG. 12 shows a permanent magnet with a seventh embodiment of the magnet coupling device for use in the swivel angle measuring device of FIG. 2; and

FIGS. 13a and 13b show a permanent magnet with an eighth embodiment of the magnet coupling device for use in the swivel angle measuring device of FIG. 2.

### DETAILED DESCRIPTION

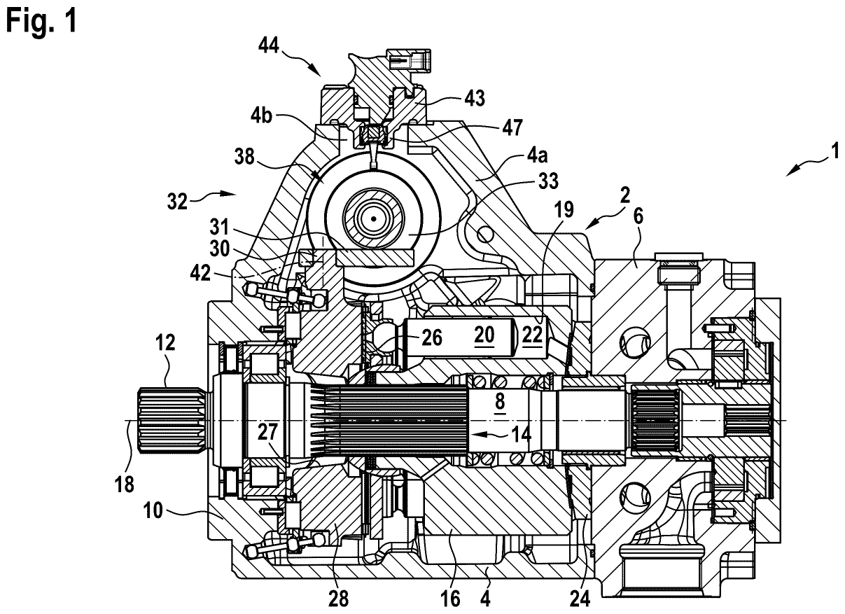

FIG. 1 shows an axial piston machine 1 with adjustable displacement volume with a swashplate design. It can be operated as a pump and as a motor. It has a housing 2 having a substantially pot-shaped housing part 4 and housing cover 6 comprising a work connection (not shown). A drive shaft 8 is rotatably mounted in the housing 2. To transmit a torque, the drive shaft 8 comprises a shaft end 12, which passes through a base 10 of the pot-shaped housing part 4.

The drive shaft 8 has external toothing 14 in a central area, via which it is rotationally connected to a cylinder drum 16. This has a plurality of cylinder bores 19 arranged on a partial circle extending concentrically to an axis of rotation 18 of the drive shaft 8 and the cylinder drum 16, in each of which a working piston 20 is axially slidably accommodated. A hydrostatic working area 22 is delimited by a pairing of working piston 20 and cylinder bore 19, which comes into a pressure mechanism connection with the work connections via a control disc 24 interspersed with through-recesses when the cylinder drum 16 rotates.

At an end face of the cylinder drum 16 facing away from the control disc 24, the working pistons 20 exit the cylinder drum 16 and are slidably mounted by their piston heads, which are held in sliding shoes, on a swashplate 26, the swivel angle of which can be adjusted relative to the axis of rotation 18. The latter is configured as a sliding surface of a swivel cradle 28 pivotably mounted in the housing part 4. The swivel cradle 28 has an approximately elongated through-recess 27, which widens away from the swashplate 26 and through which the drive shaft 8 passes through.

In order to be able to adjust the stroke of each working piston 20 and thus the stroke volume of the axial piston machine 1 (per revolution of the cylinder drum 16), the swivel cradle 28 is coupled to a hydrostatic adjustment device 32 via a pin 30 configured in one piece and a sliding block 31 rotatably mounted thereon so as to rotate about an axis of rotation 42. The sliding block 31 is slidably guided in a groove 33 of an adjustment piston 38 of the adjustment device 32.

In order to be able to indirectly detect the swivel angle of the swashplate 26 or the swivel cradle 28, a swivel angle measuring device 44 is provided. It has an approximately cuboid cover 43, which is shown as a cross-section in FIG. 1. A linear guide 47 is formed in one piece on the cover 43, which is inserted into a breakthrough 4b of an adjustment cylinder housing 4a of the pot-shaped housing part 4. A permanent magnet 46 serving as the encoder of the swivel angle measuring mechanism 44 is guided along the linear guide 47. The swivel angle measuring device 44 will be explained in more detail with reference to the following figures.

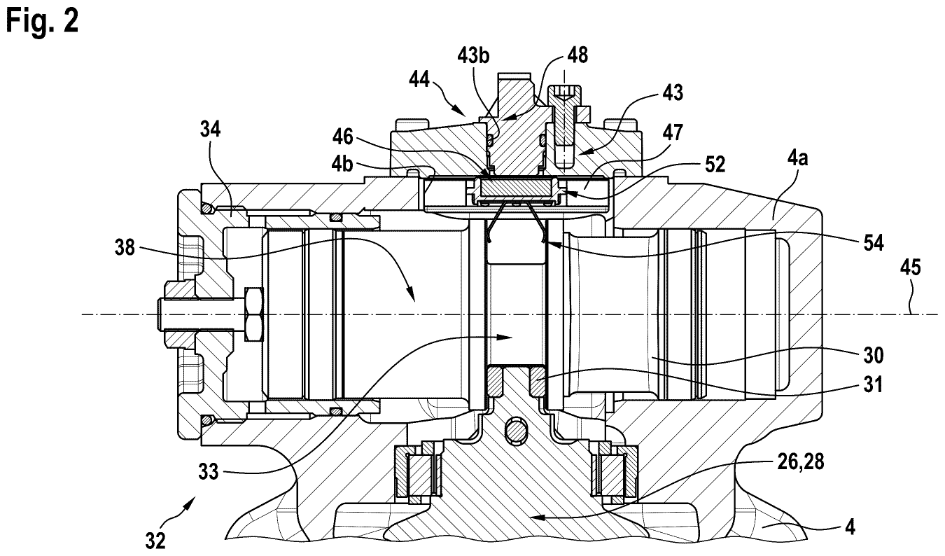

FIG. 2 shows the hydrostatic adjustment device 32 for the swivel angle. It has an adjustment cylinder 34 configured as a screw-in installation sleeve and the adjustment piston 38 accommodated therein in sections. The adjustment piston 38 is double-acting, as it can be effectively pressurized in both directions. As a result, it moves along its central axis which defines the direction of movement 45. When the adjustment piston 38 moves, the sliding block 31 inserted eccentrically (on the outer circumference) in the groove 33 is taken along in the direction of movement 45. As a result, the pin 30 inserted in the sliding block 31 is taken along, which performs a rotational movement relative to the sliding block 31. Since the pin 30 is formed in one piece on the swivel cradle 28, the swivel angle is adjusted by the movement of the adjustment piston 38.

The permanent magnet 46 is coupled to the groove 33 of the adjustment piston 38 via a so-called magnet coupling device. The essential components (of all embodiments) of the magnet coupling device are a magnet housing 52 and a spring element 54; 154; 354; 454; 554; 654. The magnet housing 52 encompasses the permanent magnet 46 on all sides and is slide-optimized so that it can be moved along the linear guide 47 without jamming and with low resistance. The spring element 54; 154; 354; 454; 554; 654 is biased and inserted into the groove 33. A direct abutment of the spring element 54; 154; 454; 554; 654 with the groove 33 is possible but not mandatory. Thus, a backlash-free transmission of the adjustment piston position to the measuring element (taker) is ensured.

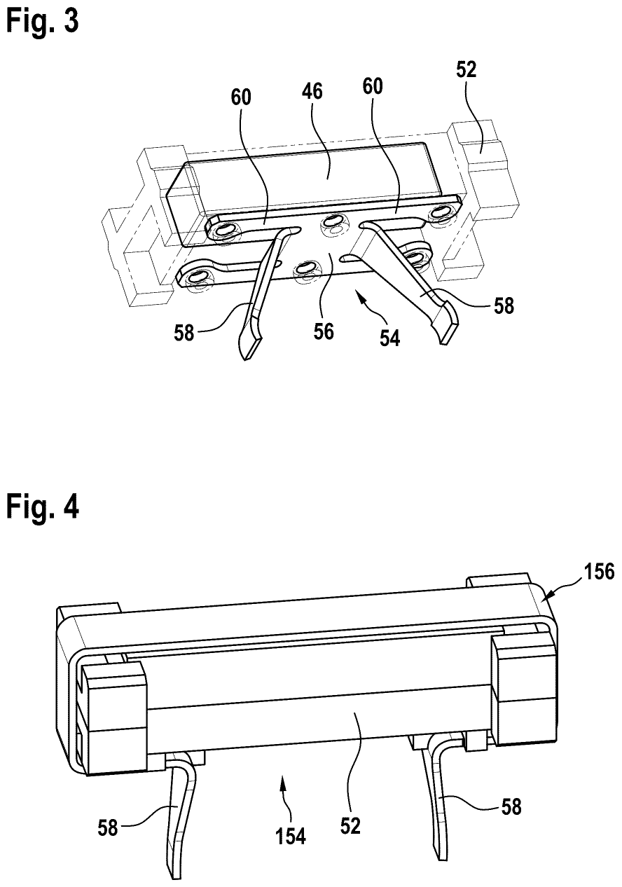

In a first embodiment of the magnet coupling device according to FIG. 3, the spring element 54 has a flat main section 56 that is attached to the side (the lower side in FIG. 3) of the magnet housing 52 facing the groove 33. From the main section 56, two elastic legs 58 extend into the groove 33 (shown in FIG. 2). The main section 56 has four webs 60 that lie together with the main section 56 in one plane. A through-recess is formed at each of the ends of the webs 60 away from the main section 56, and two through-recesses are formed in the main section 56. A (e.g., plastically deformed) lug of the magnet housing 52 extends through each of the through-recesses for fastening the spring element 54 to the magnet housing 52.

A second embodiment of the magnet coupling device according to FIG. 4 has the magnet housing 52 mentioned above. The spring element 154 of the magnet coupling device has an angled band-like or strip-like main section 156 that encompasses the magnet housing 52 on three sides not facing the groove 33 (shown in FIG. 2). An elastic leg 58 is formed at each of the two free end sections of the main section 156 of the spring element 154, which extends away from the magnet housing 52 (downwards in FIG. 4) into the groove 33.

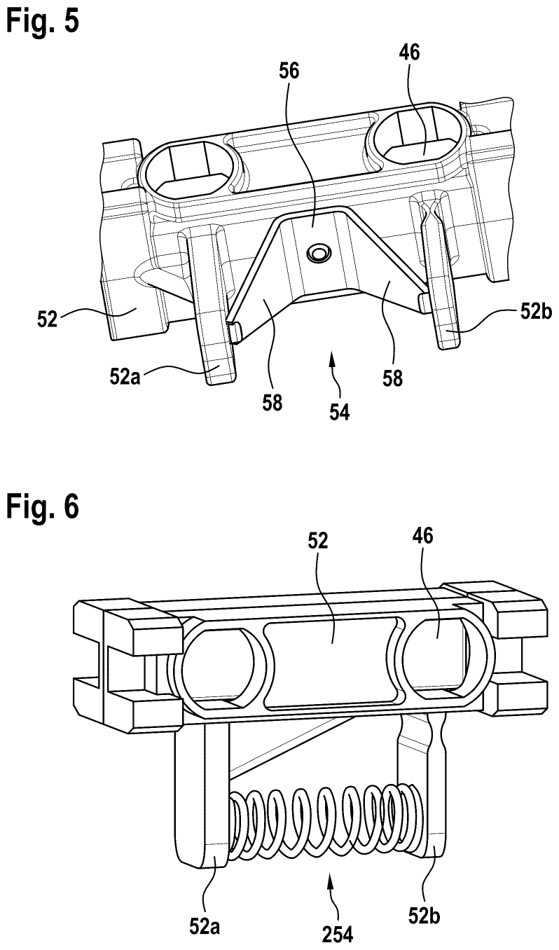

A third embodiment of the magnet coupling device according to FIGS. 5 and 6 also has the magnet housing 52 mentioned above, in which the permanent magnet 46 is enclosed. Two webs 52a, 52b are molded in one piece on the side of the magnet housing 52 facing the groove 33 (shown in FIG. 32) using the plastic injection molding procedure, that extend into the groove 33 and abut the side walls of the groove 33. One of the webs 52b has increased flexibility compared with the other web 52a.

The spring element 54; 254 of the magnet coupling device is clamped between these two webs 52a, 52b. As a result, the spring element 54; 254 has no direct contact to the side walls of the groove 33, but nevertheless clamps the permanent magnet 46 in the groove and centers it with respect to the groove 33.

FIG. 5 shows a first further development of the third embodiment. The spring element 54 has a main section 56 attached to the magnet housing 52 and two legs 58 extending away from the main section 56. A through-recess is formed on the main section of the spring element 54, through which a lug of the magnet housing 52 extends.

FIG. 6 shows a second further development of the third embodiment, in which the spring element is a coil spring 254. This is held at each end section on a round protrusion of the two webs 52a, 52b.

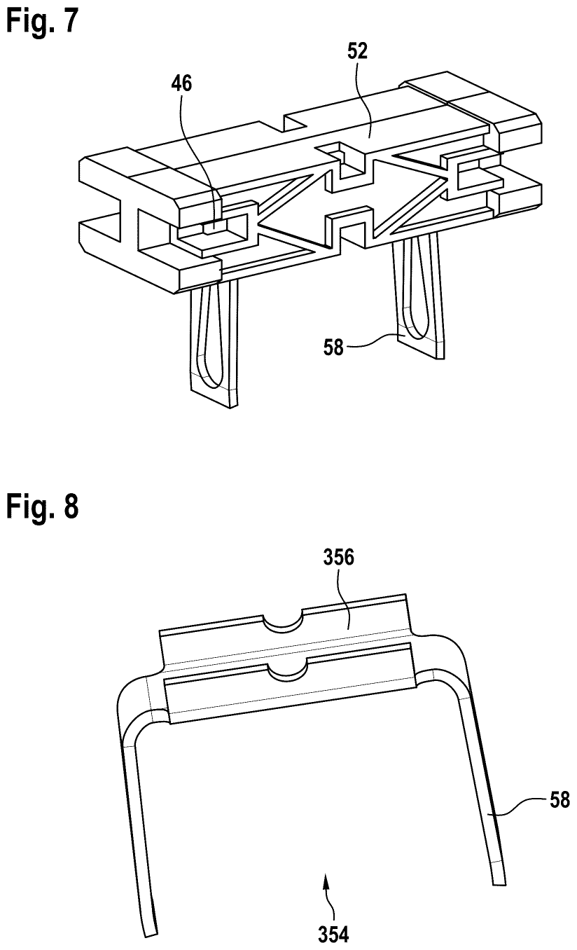

FIG. 7 shows a fourth embodiment of the magnet coupling device and FIG. 8 shows its spring element 354 in isolation. A central main section of the spring element 354 is further formed into a channel-like receptacle 356 for the permanent magnet 46. The magnet housing 52 encompasses the permanent magnet 46 together with the receptacle 356. More specifically, the receptacle 356 together with the permanent magnet 46 are molded into the magnet housing 52 using a plastic injection molding procedure. The two legs 58 of the spring element 354 extend through the side of the magnet housing 52 facing the groove 33.

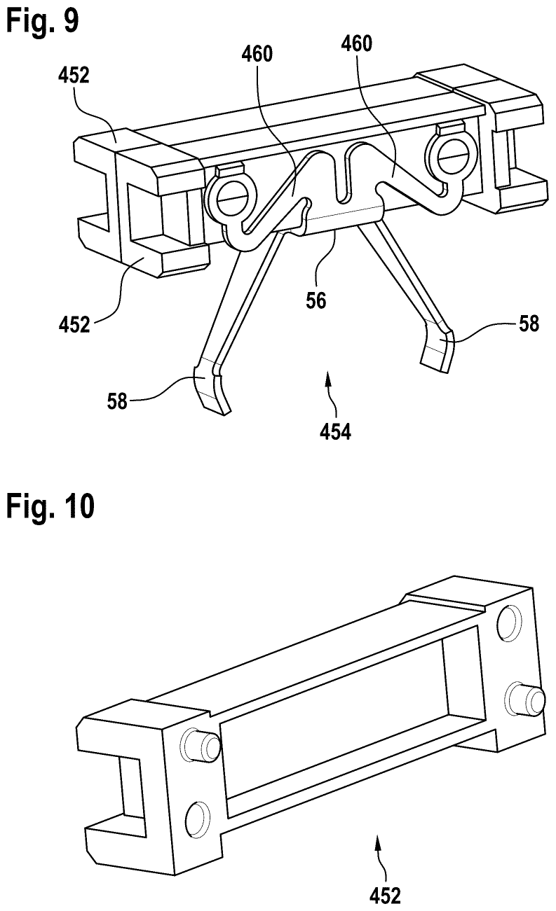

FIG. 9 shows a fifth embodiment of the magnet coupling device. This has two magnet housing halves 452, wherein the spring element 454 has a central main section 56 from which the two legs 58 and four z-shaped or s-shaped retaining legs 460 extend. The two magnet housing halves 452 are clamped between the four retaining legs 460, wherein two retaining legs 460 form a pair and abut a magnet housing half 452.

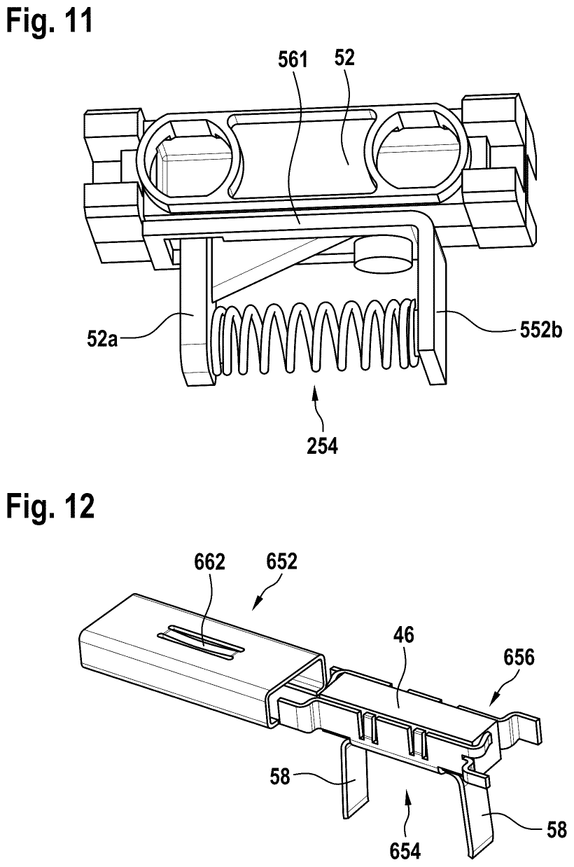

Each pair of retaining legs 460 is arranged in one piece at one of two edges which are opposite each other with respect to the direction of movement of the adjustment piston 38 (shown in FIG. 2). The retention legs 460 of a pair extend from the affected edge of the main section 56 angled away from the groove 33 (shown in FIG. 2). In FIG. 11, only one of the edges of the main section 56 and a pair of retaining legs 460 is shown.

A through-recess is formed on each retaining leg 460, and two clamping lugs are formed on each magnet housing half 452, each of which extends into a through-recess.

FIG. 10 shows one of the two magnet housing halves 452 of FIG. 9 in isolation. It can be seen that the magnet housing half 452 has two clamp holes facing the other magnet housing half 452 and two clamp pins facing the other magnet housing half 452. Due to the symmetrical arrangement, it is possible that both magnet housing halves 452 are identical in construction.

FIG. 11 shows a sixth embodiment of the magnet coupling device, in which a single web 52a is formed in one piece on the magnet housing 52, which abuts one of the side walls of the groove 33. A further web 552b is slidable on the magnet housing 52 along the direction of movement of the adjustment piston 38 (shown in FIG. 2). To this end, the further web 552b is formed in one piece on a guide section 561, which is slidably mounted on the magnet housing 52 along the direction of movement of the adjustment piston 38 (shown in FIG. 2). The guide section 561 has a slotted hole through which one guide pin and the other web 52a extend. The guide pin and the other web 52a are formed in one piece and molded on the magnet housing 52.

The two webs 52a, 552b extend into the groove 33. The spring element is configured as a coil spring 354 and is clamped between the two webs 52a, 552b. As a result, the two webs 52a, 552b are clamped against the side walls of the groove 33. Thus, the coil spring 254 has no direct contact with the side walls of the groove 33.

In a seventh embodiment of the magnet coupling device according to FIG. 12, a central main section of the spring element 654 is further formed into a trough-like receptacle 656 for the permanent magnet 46.

The magnet housing 652 is formed from a profile which, apart from a clamping section 662 on the side facing away from the groove 33, has a substantially constant approximately C-shaped cross-section across its length. The profile 652 is pushed over the permanent magnet 46 and the receptacle 656 in the direction (later) of movement 45 of the adjustment piston 38 during assembly of the magnet coupling device, and encompasses the permanent magnet 46 and the receptacle 656 on several sides. On the side facing the groove 33 (lower side in FIG. 12), the profile 652 has an opening through which the two legs 58 are moved during assembly, and through which the two legs 58 extend when the magnet coupling device is fully assembled.

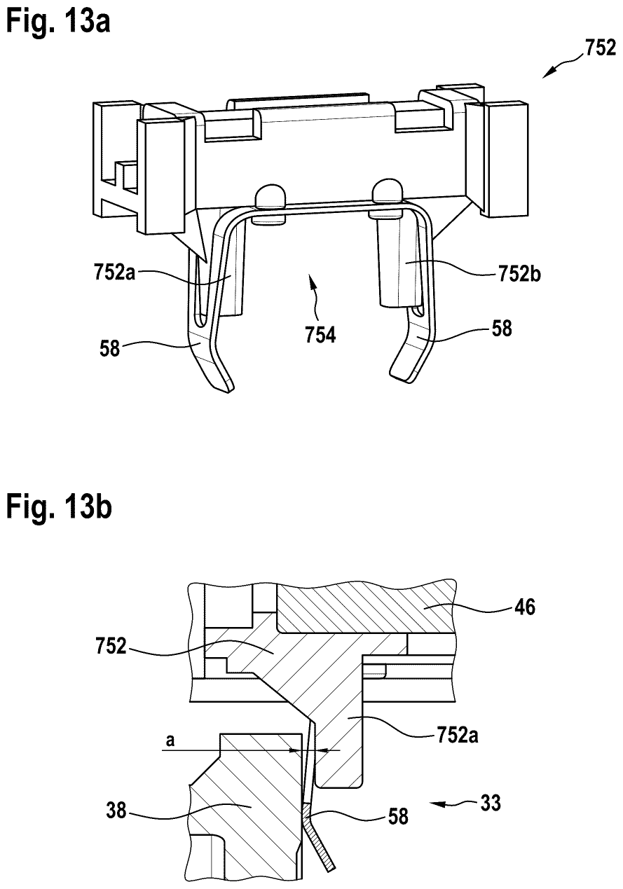

FIGS. 13a and 13b show a permanent magnet 46 (FIG. 13b) with an eighth embodiment of the magnet coupling device for use in the swivel angle measuring device of FIG. 2. In order to prevent overloads on the spring element 754, in particular on its legs 58, resulting from large amplitudes of the magnet coupling device, stops in the form of domes 752a, 752b are formed in one piece on the magnet housing 752. The spring element 754 is thus only stressed up to a stroke a (FIG. 13b).

The spring element 754 has a respective breakthrough on the legs 58 through each of which a dome 752a, 752b of the magnet housing 752 protrudes. As a result, the stroke a of the magnet coupling device is limited in the groove 33 of the adjustment piston 38.

### LIST OF REFERENCE NUMBERS

1 Axial piston machine
2 Housing
3 Pot-shaped housing part
4a Adjustment piston housing
4b Breakthrough (elongated)
6 Housing cover
8 Drive shaft
10 Base
12 Shaft end
14 External toothing
16 Cylinder drum
18 Axis of rotation
19 Cylinder bore
20 Working piston
22 Working area
24 Control disc
26 Swashplate
27 Through-recess
28 Swivel cradle
30 Pin
31 Sliding block
32 Adjustment device
34 Adjustment cylinder
38 Adjustment piston
42 Axis of rotation
43 Cover
43b Breakthrough
44 Swivel angle measuring device
45 Direction of movement
46 Permanent magnet
47 Linear guide
48 Transducer/Hall sensor
52 Magnet housing
52a Web
52b Web
54 Spring element
56 Main section
58 Leg
60 Web (of spring element)
154 Spring element
254 Coil spring
354 Spring element
356 Receptacle
452 Magnet housing half
454 Spring element
460 Retaining leg
552b Web
654 Spring element
561 Guide section
652 Magnet housing/Profile
656 Receptacle
662 Clamping section
752 Magnet housing
752a Dome
752a Dome
754 Spring element
a Stroke

What is claimed is:

1. A swivel angle measuring device for a hydrostatic axial piston machine having a swashplate, the swivel angle of which can be adjusted by way of an adjustment piston guided in an adjustment cylinder, wherein the swivel angle of the swashplate can be detected using the swivel angle measuring device, wherein the swivel angle measuring device comprises a movable encoder formed by a permanent magnet and a transducer fixed to the housing, wherein the swivel angle measuring device is translational, and wherein the permanent magnet is configured to be moved linearly and translationally by the adjustment piston along its direction of movement by way of a magnet coupling device.

2. The swivel angle measuring device according to claim 1, wherein an adjustment piston housing is penetrated by an elongated breakthrough in the direction of movement of the adjustment piston, along or in which the permanent magnet is guided linearly and translationally.

3. The swivel angle measuring device according to claim 2, wherein the breakthrough is covered by a cover, and wherein a seal between the cover and the adjustment piston housing endlessly surrounds the breakthrough.

4. The swivel angle measuring device according to claim 3, wherein the transducer is accommodated in a breakthrough of the cover.

5. The swivel angle measuring device of claim 1, wherein the adjustment piston has a circumferential groove via which it is coupled to the swashplate, and wherein the magnet coupling device enters the groove at least in sections and in a displaceable manner.

6. The swivel angle measuring device according to claim 5, wherein the magnet coupling device has a spring element, by way of which the permanent magnet is elastically braced with two side walls of the groove opposite to one another, or wherein the magnet coupling device has a spring element, that has two legs which are elastically movable relative to one another and which abut opposite side walls of the groove under preload.

7. The swivel angle measuring device according to claim 6, wherein the magnet coupling device has a magnet housing that encompasses the permanent magnet, wherein two webs are formed in one piece on the side of the magnet housing facing the groove, which extend into the groove and abut against the side walls of the groove, and wherein the spring element is clamped between the two webs.

8. The swivel angle measuring device according to claim 6, wherein the spring element has a tub-like or trough-like receptacle for the permanent magnet, and wherein the magnet coupling device has a magnet housing that encompasses the permanent magnet and the tub-like or trough-like receptacle.

9. The swivel angle measuring device according to claim 6, wherein the magnet coupling device has a magnet housing, which encompasses the permanent magnet, wherein a web is formed in one piece on the magnet housing, abutting one of the side walls of the groove, and wherein a further web is provided, which is mounted on the magnet housing, wherein the webs extend into the groove, and wherein the spring element is clamped between the two webs.

10. The swivel angle measuring device according to claim 6, wherein the magnet coupling device has a magnet housing, which encompasses the permanent magnet, wherein two stops in the form of domes are formed in one piece on the side of the magnet housing facing the groove, which extend in the direction of the groove and can be brought into contact with the side flanks of the groove, and wherein the spring element has a main section from which the two legs extend.

11. A hydrostatic axial piston machine having a swashplate, the swivel angle of which can be adjusted by way of an adjustment piston guided in an adjustment cylinder, and having a swivel angle measuring device, by way of which the swivel angle of the swashplate can be detected, wherein the swivel angle measuring device comprises a movable encoder formed by a permanent magnet and a transducer fixed to the housing, wherein the swivel angle measuring device is translational, and wherein the permanent magnet is configured to be moved linearly and translationally by the adjustment piston along its direction of movement by way of a magnet coupling device.
